(19) United States
(12) Patent Application Publication
(10) Pub. No.: US 2008/0194198 A1
(43) Pub. Date: Aug. 14, 2008

(54) DATA TRANSFER CIRCUIT, DATA TRANSFER APPARATUS, DATA TRANSFER METHOD, AND CONTROL PROGRAM

(75) Inventor: Daisuke NAMIHIRA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/030,369

(22) Filed: Feb. 13, 2008

(30) Foreign Application Priority Data
Feb. 13, 2007 (JP) JP2007-032221

(51) Int. Cl. H04B 3/36; H04B 7/14

(52) U.S. Cl. 455/7

(57) ABSTRACT

In a data transfer circuit, particular data information specifying, from among received data, particular data which circulates over a network within a certain time is stored in a particular data information storing portion, and the particular data information corresponding to the received data is retrieved from the particular data information storing portion. The particular data information registered in the particular data information storing portion is initialized after the lapse of a certain period from the reception of the particular data corresponding to the registered particular data information, and the received data is abandoned when the particular data information corresponding to the received data is retrieved from the particular data information storing portion. A data transfer apparatus, a data transfer method, and a control program are also provided.

### BACKGROUND OF THE INVENTION

1. Field of the Invention

The present invention relates to a data transfer circuit, a data transfer apparatus, a data transfer method, and a control program.

More particularly, the present invention relates to a data transfer circuit, a data transfer apparatus, a data transfer method, and a data transfer control program, which are adapted for each node of a plurality of data relay apparatuses connected to a Layer 2 Network in the Open Systems Interconnection (OSI) Reference Model for Ethernet® (registered trade name).

2. Description of the Related Art

If an Ethernet® (registered trade name) network, which is widely used at present, is constructed such that a frame to be relayed in Layer 2 of the OSI Reference Model is looped, the frame continues to eternally loop within the network loop.

On the other hand, in the case of relay using IP (Internet Protocol) for Layer 3, when TTL (Time To Live) representing the effective period of a packet is lapsed, or when a packet has passed through the number of network relay apparatuses which exceeds a Hop Limit value of the packet, the packet is abandoned and is prevented from looping eternally.

In the relay network in Layer 2, however, there is no scheme for preventing the generation of a loop, such as the TTL and the Hop Limit value.

Accordingly, once the loop is generated, a loop frame circulates through the network and an excessive load is imposed on a network system, thus resulting in a system failure.

The generation of the loop can be avoided by (i) a method of constructing a network structure such that the loop is not formed, or (ii) a method of bringing a part of the loop into a non-used state by employing a loop prevention protocol, e.g., STP (Spanning Tree Protocol) specified in IEEE802.1D.

In practice, however, there inevitably occurs a trouble that, when extending a network, a loop is formed by mistake in the constructed network, or that, in spite of using the STP, the scheme of preventing the generation of the loop fails and the network is brought into a looped state.

Particularly, if a network serviced for important communications fails due to the generation of the loop, a very serious effect is caused by shutdown of the system.

For that reason, due care has to be paid to prevent the generation of the loop when a network is constructed.

To solve said loop occurrence problem, there has been [Patent Document 1] mentioned below as a publicly known technique.

In [Patent Document 1], FIG. 11 illustrates the publicly known technique relating to this invention.

FIG. 11 shows the Layer 2 Network comprising three data relay apparatuses: a first node ND1, a second node ND2 and a third node ND3.

A multicast frame passed through the first node ND1 is then input into a first port P1 of the second node ND2 and distributed to both a second port P2 and a third port P3 thereof.

The multicast frame distributed to the third port P3 of the second node ND2 is further input into a first port P1 of the third node ND3. Then the multicast frame is output from a second port P2 of the third node ND3, returning to the first port P1 of the first node ND1.

Again, the multicast frame is redistributed to the second port P2 and the third port P3 of the first node ND1.

In this way, the multicast frame is distributed from the second port P2 of the first node ND1 and the second port P2 of the second node ND2.

Further the multicast frame is distributed in a triangle loop—the third port P3 of the first node ND1→the third port P3 of the second node ND2→the second port P2 of the third node ND3→the first port P1 of the first node ND1→the first port P1 of the second node ND2→the third port P3 of the second node ND2—as per FIG. 11.

Therefore the multicast frame will have been endlessly distributed within said loop as long as said multicast loop exists.

This is so-called a “routing loop problem at layer 2”

To solve the “routing loop problem at layer 2”, an input frame is monitored at respective node as shown in [Patent Document 1]. Where more than a certain number of the identical packets are expected to be distributed, said frame is wasted to prevent the occurrence of the loop.

More specifically, the packet information is stored in a given memory mean when a first frame arrives at a time T1 as per FIG. 11.

When the frame continuously runs in a loop LP as per FIG. 11, said frame is returned at a time T2, thus the identical frame is extracted based on the packet information stored in the given memory mean, and then the identical frame extracted is wasted to cancel the routing loop LP.
[Patent Document 1] Japanese Laid-open Patent Publication 2006-33275

### SUMMARY OF THE INVENTION

With the view of overcoming the problem described above, an object of the present invention is to provide a data transfer circuit, a data transfer apparatus, a data transfer method, and a control program, in which particular data information which specifies, from among received data, particular data which circulates over a network within a certain time is stored in a particular data information storing portion, the particular data information corresponding to the received data is retrieved from the particular data information storing portion, the particular data information registered in the particular data information storing portion is initialized after the lapse of a certain period from the reception of the particular data corresponding to the registered particular data information, and the received data is abandoned when the particular data information corresponding to the received data is retrieved from the particular data information storing portion. Even when a loop is generated in the network, the loop can be detected and a looped frame can be abandoned.

The above-described embodiments of the present invention are intended as examples, and all embodiments of the present invention are not limited to including the features described above.

### BRIEF DESCRIPTION OF THE DRAWINGS

FIG. 1 is a block diagram showing a basic configuration of a data transfer circuit according to an embodiment of the present invention;

FIG. 2 is a block diagram showing a configuration resulting from adding peripheral components to the basic configuration shown in FIG. 1;

FIG. 3 is a block diagram showing one practical example of the data transfer circuit according to the embodiment;

FIG. 4 is a flowchart of processing executed in a loop detection target extracting portion;

FIG. 5 illustrates a first example of contents of a target information table;

FIG. 6 illustrates a second example of contents of the target information table;

FIG. 7 is a flowchart of processing executed in a digest calculating portion;

FIG. 8 is a flowchart (No. 1) of processing executed in the latter stage of the digest calculating portion 21;

FIG. 9 is a flowchart (No. 2) of the processing executed in the latter stage of the digest calculating portion;

FIG. 10 is a flowchart (No. 3) of the processing executed in the latter stage of the digest calculating portion; and

FIG. 11 is an illustration for explaining a known technique related to the embodiment.

### DESCRIPTION OF THE PREFERRED EMBODIMENTS

Reference may now be made in detail to embodiments of the present invention, examples of which are illustrated in the accompanying drawings, wherein like reference numerals refer to like elements throughout.

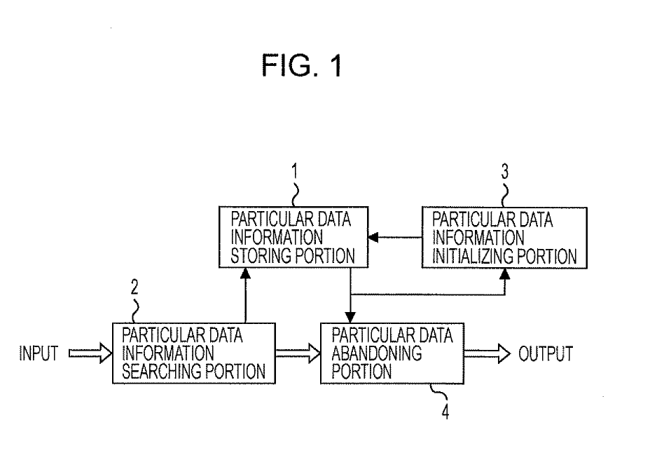

FIG. 1 is a block diagram showing a basic configuration of a data transfer circuit according to an embodiment of the present invention.

As shown in FIG. 1, the data transfer circuit according to the embodiment comprises a particular data information storing portion 1, a particular data information searching portion 2, a particular data information initializing portion 3, and a particular data abandoning portion 4.

The particular data information storing portion 1 stores particular data information specifying, from among received data, particular data which circulates over a network within a certain time.

The particular data information searching portion 2 retrieves the particular data information corresponding to the received data from the particular data information storing portion 1.

The particular data information initializing portion 3 initializes the particular data information registered in the particular data information storing portion 1 after the lapse of a certain period from the reception of the particular data corresponding to the registered particular data information.

The particular data abandoning portion 4 abandons the received data when the particular data information corresponding to the received data is retrieved from the particular data information storing portion 1.

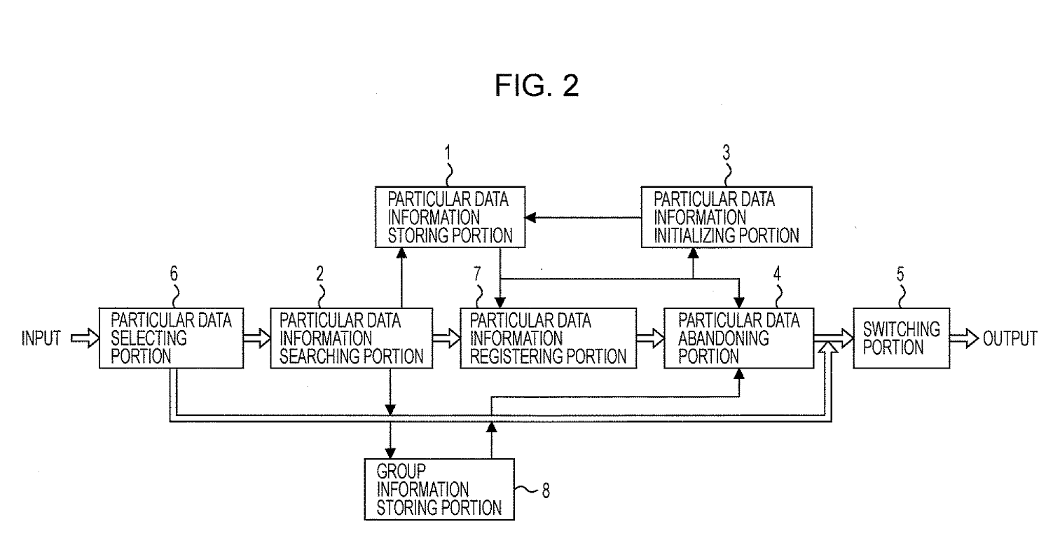

FIG. 2 is a block diagram showing a configuration resulting from adding peripheral components to the basic configuration shown in FIG. 1.

As shown in FIG. 2, the data transfer circuit further comprises a switching portion 5, a particular data selecting portion 6, a particular data information registering portion 7, and a group information storing portion 8.

The switching portion 5 transmits to the exterior, the particular data that has not been abandoned in the particular data abandoning portion 4.

The particular data selecting portion 6 performs, by using a part of the received data, selection of the received data to determine a target (particular data) which the particular data information searching portion 2 retrieves.

When the particular data information corresponding to the received data is not retrieved from the particular data information storing portion 1, the particular data information registering portion 7 registers that particular data information in the particular data information storing portion 1.

The group information storing portion 8 stores group information included in a header of the selected particular data, the group information being used to logically divide the network.

The particular data information searching portion 2 retrieves the group information of the selected particular data from the group information storing portion 8.

When the group information of the selected particular data is retrieved from the group information storing portion 8, the particular data abandoning portion 4 abandons the relevant received data.

The particular data information is preferably a summarized value (digest) of the particular data.

Also, preferably, the particular data information initializing portion 3 can change a period until reaching a time when the particular data information stored in the particular data information storing portion 1 is initialized.

The particular data selecting portion 6 outputs data other than the selected particular data to the switching portion 5 while bypassing the particular data information searching portion 2 and the particular data information abandoning portion 4.

Further, the particular data selecting portion 6 is able to abandon all of the particular data selected during a certain period.

The data transfer circuit according to the embodiment, described above with reference to FIGS. 1 and 2, will be described in more detail in connection with a practical example.

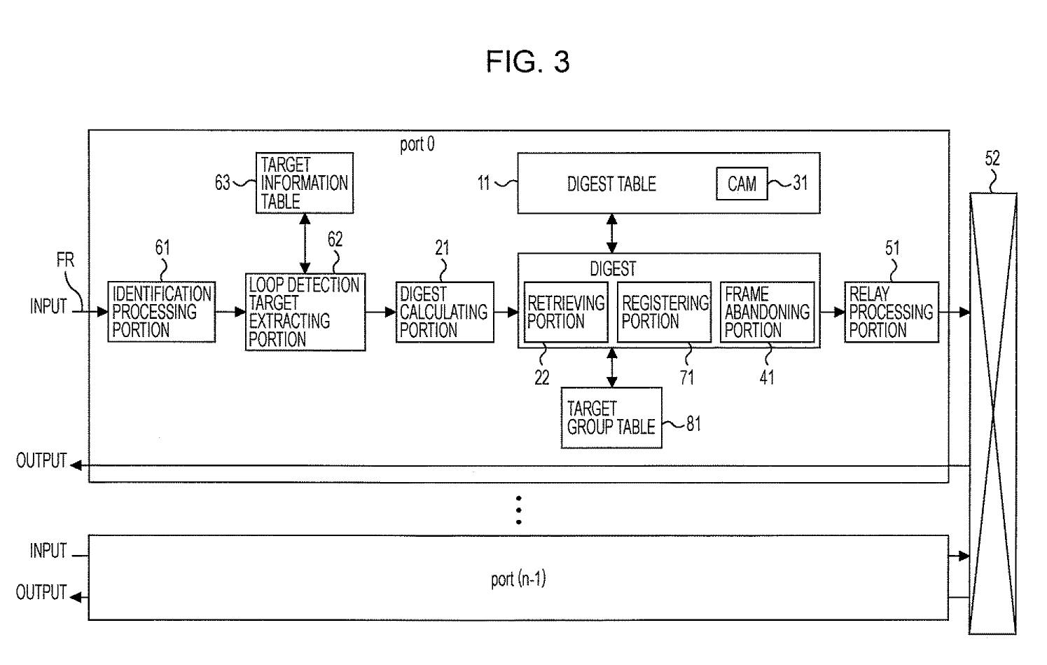

FIG. 3 is a block diagram showing one practical example of the data transfer circuit according to the embodiment.

In FIG. 3, the particular data information storing portion 1, shown in both FIGS. 1 and 2, is implemented as a digest table 11.

The particular data information searching portion 2 is implemented as a digest calculating portion 21 and a digest retrieving portion 22.

The particular data information initializing portion 3 is implemented as a CAM (Content Addressable Memory) 31.

The particular data abandoning portion 4 is implemented as a frame abandoning portion 41.

Moreover, in FIG. 3, the switching portion 5 shown in FIG. 2 is implemented as a relay processing portion 51 and an internal switch 52.

The particular data selecting portion 6 is implemented as an identification processing portion 61, a loop detection target extracting portion 62, and a target information table 63.

The particular data information registering portion 7 is implemented as a digest registering portion 71.

The group information storing portion 8 is implemented as a target group table 81.

FIG. 3 shows the data transfer circuit which is incorporated in a data relay apparatus having a number n of ports in a one-to-one relation.

Note that all the ports have the same configuration and therefore the configuration of only a port 0 is described below in detail.

In FIG. 3, a frame FR input to the port 0 successively passes through the identification processing portion 61, the loop detection target extracting portion 62, the digest calculating portion 21, the digest retrieving portion 22, the digest registering portion 71, and the frame abandoning portion 41. Further, the input frame FR is applied to the internal switch 52 through the relay processing portion 51 and is then output to a predetermined destination.

More specifically, header information of the input frame FR is extracted in the identification processing portion 61.

The header information is, e.g., a MAC (Media Access Control) address or an IP (Internet Protocol) address.

The extracted header information, e.g., the MAC address, is transferred to the succeeding blocks.

The identification processing portion 61 is one generally used in an ordinary data relay apparatus and can be implemented by employing the generally used one as it is.

The loop detection target extracting portion 62 in the next stage extracts a frame that is a target to be checked by loop detection.

In other words, the loop detection target extracting portion 62 determines whether the input frame is processed or not in the succeeding stage which includes the digest calculating portion 21, the digest retrieving portion 22, and the digest registering portion 71.

What is target information to be checked is held in the target information table 63.

Also, what target information is selectable can be set at the user's discretion.

Thus, a frame as a target of the loop detection can be set as desired. In other words, a problem of abandoning identical packets when they arrive successively in a large number, can be avoided by setting the relevant frame to be other than the target of the loop detection in the loop detection target extracting portion 62.

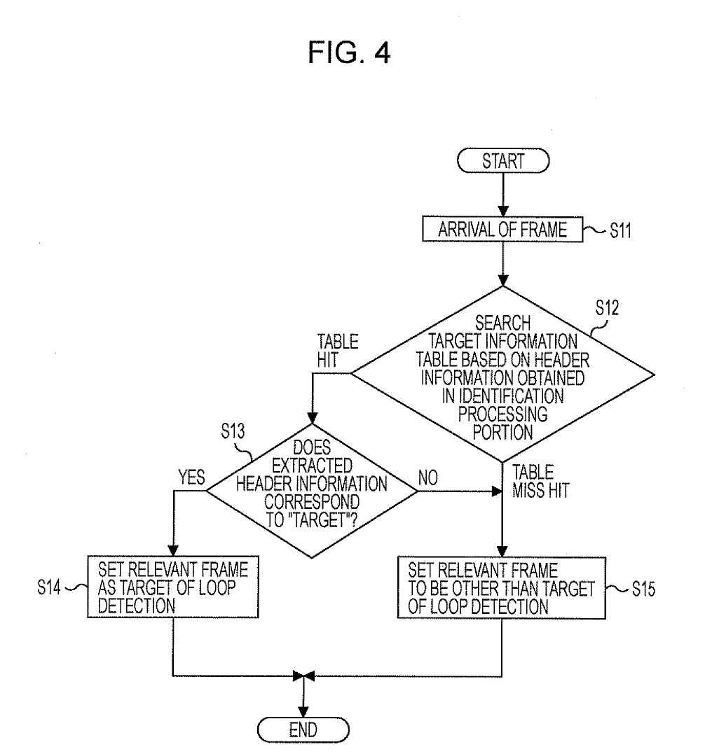

The processing executed in the loop detection target extracting portion 62 will be described next with reference to FIG. 4.

FIG. 4 is a flowchart of the processing executed in the loop detection target extracting portion 62.

When the frame FR arrives at the loop detection target extracting portion 62 in operation S11, the target information table 63 is searched in operation S12 based on the header information (e.g., the MAC address or the IP address) which has been obtained in the identification processing portion 61.

If a hit is found by the search in operation S12 (i.e., Table Hit), it is further determined in operation S13 whether the extracted header information corresponds to the “target” of the loop detection.

If the extracted header information corresponds to the “target” of the loop detection (i.e., Yes in operation S13), the relevant frame FR is set as the target of the loop detection in operation S14.

If a table hit is found, but it is determined in operation S13 that the extracted header information does not correspond to the “target” of the loop detection (i.e., No in operation S13), the relevant frame FR is set to be other than the target of the loop detection in operation S15.

On the other hand, if no hit is found as a result of the table search in operation S12 (i.e., Table Miss Hit), S12 (i.e., Table Hit), it is further determined in operation S13 whether the extracted header information corresponds to the “target” of the loop detection.

If the extracted header information corresponds to the “target” of the loop detection (i.e., Yes in operation S13), the relevant frame FR is set as the target of the loop detection in operation S14.

If a table hit is found, but it is determined in operation S13 that the extracted header information does not correspond to the “target” of the loop detection (i.e., No in operation S13), the relevant frame FR is set to be other than the target of the loop detection in operation S15.

On the other hand, if no hit is found as a result of the table search in operation S12 (i.e., Table Miss Hit), the relevant frame FR is also set to be other than the target of the loop detection in operation S15.

The information indicating whether the relevant frame is set as the target of the loop detection or not, which is obtained with the processing shown in the flowchart of FIG. 4, is transferred to the succeeding stage including the digest calculating portion 21, the digest retrieving portion 22, and the digest registering portion 71.

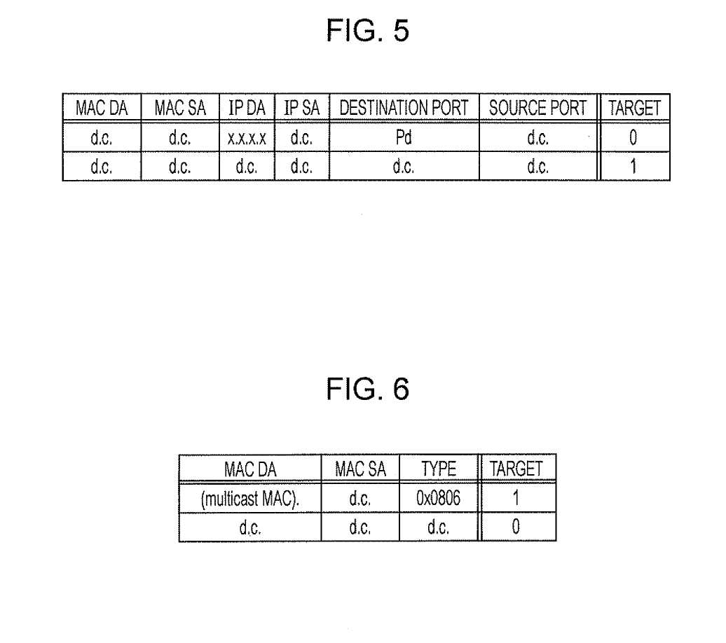

The contents of the target information table 63 will be described in more detail with reference to FIG. 5.

FIG. 5 illustrates a first example of the contents of the target information table 63, and FIG. 6 illustrates a second example thereof.

In the first example of FIG. 5, information of MAC address (source address SA and destination address DA) of Layer 2, information of IP address (SA and DA), port information of TCP/UDP (Transmission Control Protocol/User Datagram Protocol), etc. can be designated as the information corresponding to the target of the loop detection.

In FIG. 5, “d.c.” put in a search field represents “don't care” and means that designation is not required in the relevant field.

Further, in FIG. 5, when a value put in a “target” field is 1, this means that the input frame is the target of the loop detection, and when a value put in the “target” field is 0, this means that the input frame is other than the target of the loop detection.

More specifically, the first example of FIG. 5 represents the case that when an input frame has an IP destination address of “x.x.x.x”, the relevant input frame is one destined for a particular port, and that a frame having a destination port of “Pd” is other than the target of the loop detection (“0” in the “target” field) and other frames than such a frame is the target of the loop detection (“1” in the “target” field).

On the other hand, in the second example of FIG. 6, only the information of MAC address (DA and SA) of Layer 2 and a “type” value indicating the type of Layer 3 can be designated as the information corresponding to the target of the loop detection.

More specifically, the second example of FIG. 6 represents the case that when MAC DA represents a multicast MAC frame (broadcast frame) and the type value represents a frame of 0x0806, i.e., when it represents an ARP (Address Resolution Protocol) frame according to the ARP which is a TCP/IP protocol for coupling an IP address and a MAC address with each other, the relevant input frame (ARP frame) is the target of the loop detection (“1” in the “target” field) and other frames are other than the target of the loop detection (“0” in the “target” field).

The information indicating whether the input frame FR is determined as the target of the loop detection or not is obtained as described above and is transferred to the digest calculating portion 21 in the succeeding block.

Details of the digest calculating portion 21 are as follows.

For the input frame FR which has been determined to be the target of the loop detection in the loop detection target extracting portion 62 in the preceding stage, the digest calculating portion 21 calculates digest information (summarized value) of the relevant input frame.

The information indicating whether the input frame is the target of the loop detection and the result (digest) calculated in the digest calculating portion 21 are transferred to the succeeding stage which includes the digest retrieving portion 22 and the digest registering portion 71.

The digest is obtained by converting each frame to data (summarized value) having a shorter byte length than that of the frame in order to simplify comparison of identity between two frames (i.e., as to whether two frames are the same).

The digest can be calculated by using the so-called Hash function, e.g., MD5 or SHA-1, which is generally used to produce a message digest.

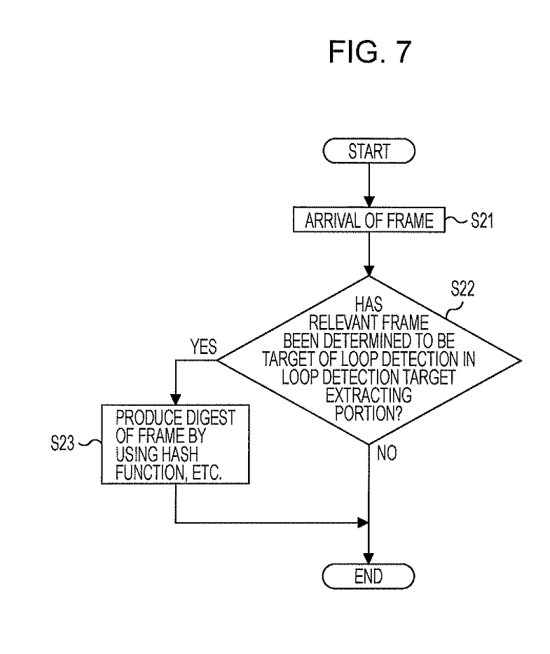

The processing executed in the digest calculating portion 21 will be described below with reference to FIG. 7.

FIG. 7 is a flowchart of the processing executed in the digest calculating portion 21.

In operation S21, a frame FR is input from the loop detection target extracting portion 62.

In operation S22, it is checked whether the input frame FR has been determined to be the target of the loop detection in the loop detection target extracting portion 62.

If it is determined in operation S22 that the input frame FR is the target of the loop detection (i.e., Yes in operation S22), a digest of the input frame FR is calculated in operation S23 by using the Hash function, described above, to produce the digest of the input frame FR.

On the other hand, if it is determined in operation S22 that the input frame FR is other than the target of the loop detection, the input frame FR is transferred directly to the relay processing portion 51 from the digest calculating portion 21.

The digest retrieving portion 22, the digest registering portion 71, and the frame abandoning portion 41 will now be described in more detail.

First, the digest table 11 is searched by using the digest obtained in the digest calculating portion 21. Then, depending on a search result, it is determined whether the input frame FR is to be abandoned in the frame abandoning portion 41.

If the search of the digest table 11 results in a miss hit, i.e., if the frame being the same as the input frame FR is not found, the digest of the input frame FR is newly registered in the digest table 11 by the digest registering portion 71.

More specifically, effective loop detection and loop cancelation can be realized by executing a method of determining whether the input frame FR is to be abandoned and a method of registering the digest in the digest table 11 as described in the following (1) and (2).

(1) The digest is registered in the digest table 11 while an aging time of the digest is set to such a short time that, after registering an entry of the digest, the entry is erased immediately.

Because a looped frame arrives again in a very short time, it is sufficient to hold the entry of the digest registered for a period just exceeding the very short time.

If a hit with the entry is found by the search of the digest table 11, the aging time of the relevant entry is reset.

Only when a frame having a load of not smaller than a certain level is input, the search is executed before the aging time is expired.

Accordingly, the aging function can be utilized to determine whether there is an input having a load of not smaller than a particular level at which it can be determined that the frame is looped.

In the embodiment, the aging function (including reset of the aging time of the relevant entry in the case of a hit) is realized by employing, as the CAM 31, the function of the existing CAM. Therefore, an additional circuit for installing hardware is not required.

The CAM 31 has not only the reverse function that is usually employed for relay of data and that when the data is input to a memory, an address storing the input data is output, but also the aging function that when a preset time is lapsed from the time of writing of data, the contents of the relevant data are erased.

(2) When the frame abandoning process is executed upon detection of the looped frame, effective loop detection and loop cancelation can be realized by selecting one of the following methods (i) to (iii).

(i) “Method of abandoning only the frame for which a hit with the digest table 11 is found”

Frames for each of which a hit with the digest table 11 can be found are only ones relayed in Layer 2.

In view of the above, the loop detection target extracting portion 62 is set to determine a frame, which is a routing target (i.e., a frame relayed in Layer 3), to be other than the target of the loop detection, and to abandon only a frame that is actually looped.

This method can avoid the problem of abandoning a frame relayed in Layer 3, i.e., a frame that is never looped.

(ii) Method of, when the frame abandoning process is executed, abandoning prior to starting the search of the digest table 11 all frames, which have been each determined to be the target of the loop detection in the loop detection target extracting portion 62, for a certain time designated by a user in advancer”

As with the above-mentioned (i), this method (ii) can also avoid the problem of abandoning a frame other than the target of the loop detection, i.e., a frame that is never looped. In addition, this method (ii) has the following advantage in comparison with the method (i).

With the method (i), when the frame becoming the target of the loop detection arrives again after the looped frame has been abandoned, the looped state is produced at that moment.

Accordingly, the process of abandoning the relevant frame has to be repeated again thereafter.

This means that some frames are looped over the actual network.

To avoid such a situation, all frames having been each determined to be the target of the loop detection are abandoned for the certain time.

As a result, all frames including ones that are possibly looped are prevented from flowing over the actual network for the certain time, and the line band can be more efficiently utilized.

(iii) “Method of in addition to the method (ii), extracting a “group” from header information of each input frame, registering the group of the frame, which has been detected as being looped, in the target group table 81, searching the target group table 81 based on information of the group of each frame when the frame is input, and abandoning the frame only when a hit with the target group table 81 is found”

With the above-mentioned (ii), when the loop detection is performed, the frames being each the target of the loop detection are all abandoned.

In a practical case, however, a Layer 2 Network is often constructed as a plurality of Layer 2 Networks which are logically divided by using VLAN (Virtual LAN: LAN in which virtual groups are set independently of physical connection layout of the LAN).

Further, a plurality of VLANs are often constructed such that one or more VLANs are looped, while other one or more VLANs are not looped. Such an arrangement causes a drawback that when a looped frame is detected in the looped VLAN, the same frame flowing in the other one or more VLANs is also abandoned for the reason that it is the frame being the target of the loop detection.

Even in the network internally logically divided into VLANs, for example, this method (iii) can overcome the above-mentioned drawback by managing the loop detecting and frame abandoning process in units of group.

The processing executed in the above-described portions 22, 71 and 41 will be described below with reference to the drawings.

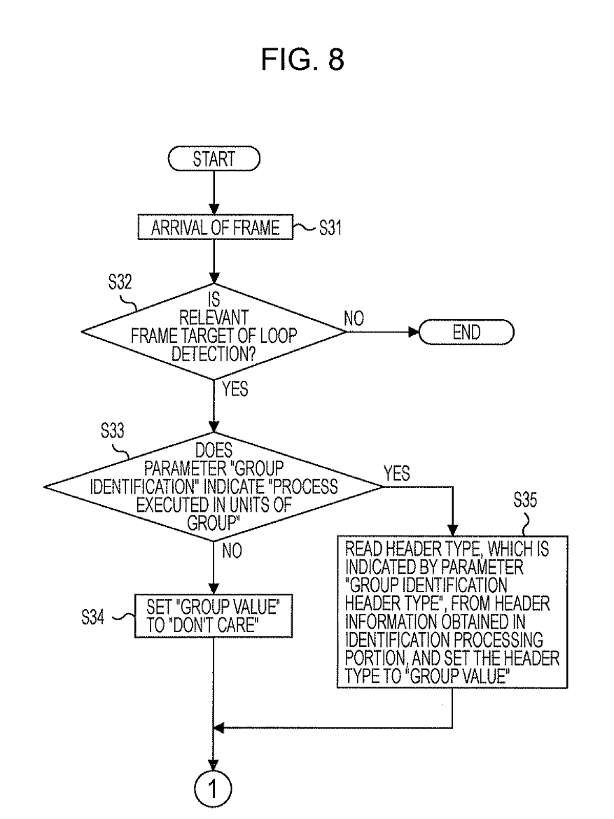

FIGS. 8, 9 and 10 are respectively a flowchart (No. 1), a flowchart (No. 2), and a flowchart (No. 3) showing the processing executed in the stage (including 22, 71 and 41) subsequent to the digest calculating portion 21.

Prior to explaining those flowcharts, five internal parameters (i) to (v) used in the following are explained.

Note that the five internal parameters can be all optionally designated by the user.

(i) Frame Abandonment Type: A flag indicates whether only the relevant frame is abandoned or the frames having been determined to be the target of the loop detection in the loop detection target extracting portion 62 are all abandoned in the frame abandoning process 41.

In other words, this flag indicates the abandonment of “only the relevant frame” or “all the target frames”.

(ii) Group Identification: A flag indicates whether the process of extracting group information from a frame header and executing the loop detection and the frame abandonment is executed in units of group.

In other words, this flag indicates “the process executed in units of group” or “the process not executed in units of group”.

(iii) Group Identification Header Type: When the flag for the “group identification” in above (ii) indicates “the process executed in units of group”, this parameter indicates a header type that is employed as a group value.

One example of this parameter is “VLAN ID” or an “Ether type value”.

(iv) Abandonment Timer: A parameter indicates a frame abandonment time when the abandonment of “all the target frames” is designated as “Frame Abandonment Type” in (i).

(v) Digest Registration Timer: A parameter indicates an aging time of the entry registered in the digest table 11.

This parameter is decided depending on the band for which the loop detection is performed.

As one example, the time designated by the digest registration timer is 1/100 sec in the case of executing the loop detection when the same frame arrives in the band of not lower than 100 pps (packet per second).

The flowcharts of FIGS. 8-10 will now be described by using the thus-defined five parameters (i) to (v).

First, referring to FIG. 8, the processing is executed as follows.

Operation S31: A frame FR arrives at the digest retrieving portion 22.

Operation S32: Whether the frame FR is the target of the loop detection is determined based on the information transferred from the loop detection target extracting portion 62.

If the frame FR is not the target of the loop detection, the relevant frame FR is transferred to the relay processing portion 51 while bypassing the succeeding stage (22, 71 and 41).

Operation S33: If the relevant frame FR is determined to be the target of the loop detection in operation S32, it is further determined for the relevant frame FR whether the parameter “Group Identification” in the above-mentioned (ii) indicates “the process executed in units of group”.

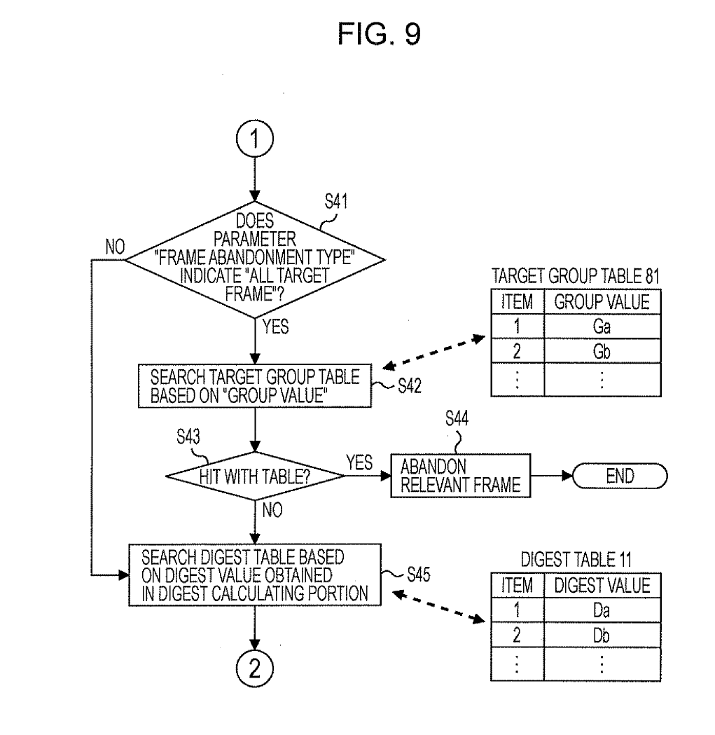

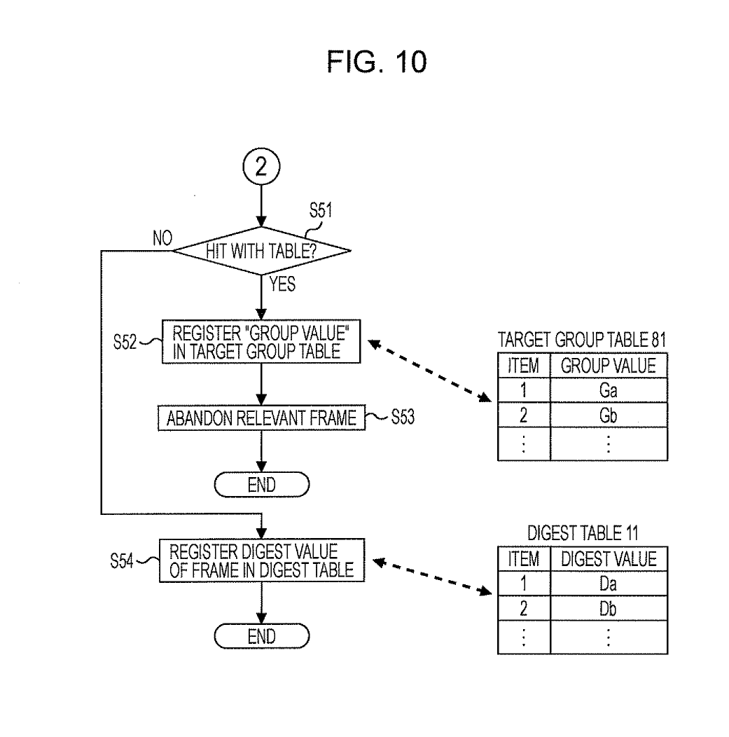

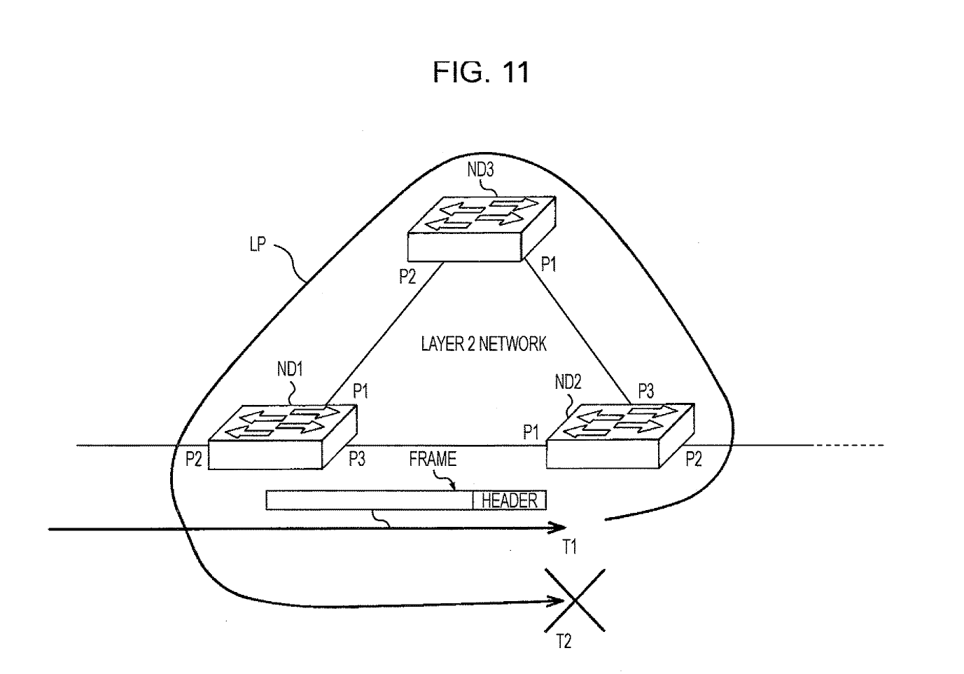

Operation S34: A “group value” in the target group table 81, shown on the right side of FIGS. 9 and 10, is set to “don't care”.

Operation S35: The “header type” mentioned in the parameter “Group Identification Header Type” in the above-mentioned (iii) is read from the header information obtained in the identification processing portion 61 and is set as the “group value”.

Next, referring to FIG. 9, the processing is advanced to operation S41 from operation S34 or S35 in FIG. 8.

Operation S41: The digest retrieving portion 22 determines whether the parameter “Frame Abandonment Type” in the above-mentioned (i) indicates the abandonment of “all the target frames”.

Operation S42: The target group table 81 is searched by using the “group value” (e.g., Ga or Gb in the target group table 81 shown on the right side of FIG. 9).

When the “group value” is given by “don't care” (d.c.), namely when the parameter “Group Identification” in the above-mentioned (ii) indicates “the process not executed in units of group”, the search is executed while masking all group values.

In that case, because all group values are masked, a hit is found even when just one entry is registered in the CAM.

Operation S43: It is determined whether a hit with the group value in the target group table 81 is found by the search in operation S42.

Operation S44: The frame for which a hit has been found in operation S43 is abandoned in the frame abandoning portion 41.

Operation S45: The digest table 11 is searched by using the digest value which has been obtained by calculation for the relevant frame in the digest calculating portion 21.

One example of the contents of the digest table 11 is shown on the right side of FIG. 9.

If the determination result in operation S41 is “No”, the processing is skipped to operation S45.

Referring to FIG. 10, the processing is further executed as follows:

Operation S51: It is determined whether a hit with the digest value in the digest table 11 is found by the search of the digest table 11 in operation S45.

Operation S52: If a hit is found in operation S51 (i.e., “Yes”), the “group value” of the relevant frame is registered in the target group table 81 as shown on the right side of FIG. 10.

In that case, by setting the aging time of the target group table 81, which has been retrieved from the CAM, to be equal to the time designated by the above-mentioned parameter (iv) “Abandonment Timer”, a comparison process of checking the lapse of the aging time can be dispensed with.

Operation S53: After registering the “group value”, the relevant frame is abandoned and the series of processes is brought to an end (END).

On the other hand, if the determination result in operation S51 is “No”, the processing is skipped to operation S54.

Operation S54: The digest value of the relevant frame is registered in the digest table 11 as shown on the right side of FIG. 10 and the series of processes is brought to an end (END).

Also in that case, as in above operation S52, the aging time of the digest table 11 is preferably set to be equal to the time designated by the above-mentioned parameter (v) “Digest Registration Timer”.

Operations S31 to S54 in FIGS. 8-10 represent the operations of the loop detecting and frame abandoning process.

A processing block subsequent to those operations includes the relay processing portion 51 and the internal switch 52 shown in FIG. 3. The relay processing portion 51 serves to execute relay processing for Layer 2 (or Layer 2/Layer 3) and can be constituted in a similar structure to that of the known data relay apparatus.

The internal switch 52 serves to transfer the frame to a destination port which is determined by the relay processing portion 51, and it can also be constituted in a similar structure to that of the known data relay apparatus.

While the data transfer circuit according to the embodiment has been described in detail, other embodiments of the present invention can be implemented as a data transfer apparatus, a data transfer method, and a control program.

Thus, by applying any of the embodiments to the data relay apparatus for the Layer 2 Network of Ethernet (registered trade name), a looped frame can be detected and the detected looped frame can be abandoned.

Therefore, unlike the case of using the loop prevention protocol such as STP, the network can be reliably prevented from being failed and quick avoidance of a network failure can be realized.

In the embodiment, since continuous arrival of the same frame is set as a condition for the loop detection, there is a possibility of erroneous detection when the same frame flows successively in large number over the network.

Even in that case, however the erroneous detection can be avoided by employing the method of designating the loop target according to the embodiment, because the corresponding frame can be previously set to be other than the target of the loop detection.

Further, in the embodiment, frames are divided into groups based on the header information of each frame such that the loop detecting and frame abandoning process can be controlled separately in units of group.

With that feature of the embodiment, in the Layer 2 Network using VLANs, the loop detecting and frame abandoning process can be executed for each VLAN. Accordingly, the data transfer circuit of the embodiment can realize the function comparable or superior to MSTP (Multiple STP) that is at a higher level than STP.

Although a few preferred embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A data transfer circuit comprising:
a particular data information storing portion for storing particular data information specifying, from among received data, particular data which circulates over a network within a certain time;
a particular data information searching portion for retrieving the particular data information corresponding to the received data from the particular data information storing portion;
a particular data information initializing portion for initializing the particular data information registered in the particular data information storing portion after the lapse of a certain period from the reception of the particular data corresponding to the registered particular data information; and
a particular data abandoning portion for abandoning the received data when the particular data information corresponding to the received data is retrieved from the particular data information storing portion.

2. The data transfer circuit according to claim 1, further comprising a particular data selecting portion for performing, by using a part of the received data, selection of the received data to determine a target for which the particular data information searching portion makes retrieval.

3. The data transfer circuit according to claim 1, wherein the particular data information is a summarized value of the particular data.

4. The data transfer circuit according to claim 1, further comprising a particular data information registering portion,
wherein when the particular data information corresponding to the received data is not retrieved from the particular data information storing portion, the particular data information registering portion registers that particular data information in the particular data information storing portion.

5. The data transfer circuit according to claim 1, wherein the particular data information initializing portion can change a period until reaching a time when the particular data information stored in the particular data information storing portion is initialized.

6. A data transfer apparatus comprising:
a particular data information storing portion for storing particular data information specifying, from among received data, particular data which circulates over a network within a certain time;
a particular data information searching portion for retrieving the particular data information corresponding to the received data from the particular data information storing portion;
a particular data information initializing portion for initializing the particular data information registered in the particular data information storing portion after the lapse of a certain period from the reception of the particular data corresponding to the registered particular data information; and
a particular data abandoning portion for abandoning the received data when the particular data information corresponding to the received data is retrieved from the particular data information storing portion.

7. A data transfer method for a data transfer apparatus comprising a particular data information storing portion for storing particular data information specifying, from among received data, particular data which circulates over a network within a certain time, the data transfer method comprising the operations of:
retrieving the particular data information corresponding to the received data from the particular data information storing portion;
initializing the particular data information registered in the particular data information storing portion after the lapse of a certain period from the reception of the particular data corresponding to the registered particular data information; and
abandoning the received data when the particular data information corresponding to the received data is retrieved from the particular data information storing portion.

8. A computer readable media comprising a control program configured for instructing a data transfer apparatus comprising a particular data information storing portion for storing particular data information specifying, from among received data, particular data which circulates over a network within a certain time, when executed, causing the data transfer apparatus to execute the operations of:
retrieving the particular data information corresponding to the received data from the particular data information storing portion;
initializing the particular data information registered in the particular data information storing portion after the lapse of a certain period from the reception of the particular data corresponding to the registered particular data information; and
abandoning the received data when the particular data information corresponding to the received data is retrieved from the particular data information storing portion.
